(19) United States
(12) Patent Application Publication
(10) Pub. No.: US 2018/0224548 A1
(43) Pub. Date: Aug. 9, 2018

(54) Distance Measuring Apparatus, Distance Measuring Method, and Shape Measuring Apparatus

(71) Applicant: Hitachi, Ltd., Chiyoda-ku, Tokyo (JP)

(72) Inventors: Tatsuo HARIYAMA, Tokyo (JP); Masahiro WATANABE, Tokyo (JP)

(73) Assignee: Hitachi ,Ltd.

(21) Appl. No.: 15/751,318

(22) PCT Filed: Apr. 26, 2016
(86) PCT No.: PCT/JP2016/063054

§ 371 Date: Feb. 8, 2018

(51) Int. Cl. G01S 17/36; G01S 7/497; G01S 7/491

(52) U.S. Cl. CPC G01S 17/36; G01S 7/4912; G01S 7/497

(57) ABSTRACT

The present disclosure discloses a distance measuring apparatus that enables measuring a distance of a target object with high accuracy. The distance measuring apparatus includes a light source unit that emits a plurality of light beams having different wavelengths, an irradiation optical element that irradiates a measurement target with the emitted light beams, a light receiving unit that receives the light reflected by the measurement target, and a processor that calculates the distance from the light source to the measurement target from the signal detected by the light receiving element. Then, the processor executes frequency calculation processing of calculating a peak frequency corresponding to each wavelength from the signal detected by the light receiving unit and distance calculation processing of reducing the Doppler shift errors caused by the oscillation of the measurement target from the peak frequency corresponding to each wavelength to calculate the distance.

### TECHNICAL FIELD

The present disclosure relates to a distance measuring apparatus, a distance measuring method, and a shape measuring apparatus, for example, a technique for measuring a distance from a light source to a measurement target in a non-contact manner.

### BACKGROUND ART

A frequency modulated continuous waves (FMCW) method is known as a method of measuring a distance to a measurement target in a non-contact manner. As an example of the distance measurement using the FMCW method, the techniques described in Patent Document 1 or 2 may be cited. PTL 1 discloses a technique in which light emitted from a light source for measurement is branched into two, a target is irradiated by shifting an optical frequency sweep cycle by a half cycle from each other, and distance errors due to the Doppler shift caused by the oscillation of the measurement target are reduced. In addition, PTL 2 discloses a technique in which two light sources whose polarizations are orthogonal to each other are provided, and a target is irradiated by shifting an optical frequency sweep cycle by a half cycle from each other, and distance errors due to the Doppler shift caused by the oscillation of the measurement target is reduced.

### CITATION LIST

### Patent Literature

PTL 1: JP-A-9-257415

PTL 2: JP-T-2008-531993

### SUMMARY OF INVENTION

### Technical Problem

FIG. 1 is a diagram showing one configuration example of an FMCW system. According to FIG. 1, when a triangular wave current is injected from an oscillator (signal generator) 102 to a semiconductor laser 101 and a drive current is modulated, FM light whose frequency is swept in time at a constant modulation speed is generated. The FM light is split by a beam splitter 202, a part of the output light is irradiated to a measurement target 110, and a part of the output light is reflected by a reference mirror 201. The reflected light from the measurement target and the interference light of the reference light are detected by a light receiver 203, and the detected beat signal is analyzed by a PC 114 and displayed on a monitor (screen) 115.

FIG. 2 is a diagram showing an example of a beat signal 301 observed by a light receiver. In FIG. 2, the horizontal axis of the graph is an observed beat frequency, and the vertical axis is a signal intensity.

FIG. 3 is a diagram showing a principle of distance measurement. The temporal change of the optical frequency in the light receiver of a reference light 401 and a measurement light 402 is shown, the horizontal axis of the graph is time, and the vertical axis is an optical frequency. A beat frequency f_{b}, a difference Δt between the arrival time of the reference light 401 and the measurement light 402 to the light receiver, a frequency sweep width Δν, and a modulation cycle T have a relationship of Equation (1).

$$\begin{matrix}[ Equation 1 ] & \\ Δ t = \frac{T}{2 Δ ν} {f}_{b} & ( 1 )\end{matrix}$$

Therefore, a distance L to the measurement target may be expressed by Equation (2) using a light speed c in the atmosphere.

$$\begin{matrix}[ Equation 2 ] & \\ L = \frac{cT}{2 Δν} {f}_{b} & ( 2 )\end{matrix}$$

However, in the case of using the FMCW method, the measurement target oscillates and the Doppler shift as shown in Equation (3) occurs.

$$\begin{matrix}[ Equation 3 ] & \\ Δ f = ν \frac{2 V}{c} cos θ & ( 3 )\end{matrix}$$

Here, ν is the frequency of the irradiation laser, V is the oscillation speed of the target, c is the light speed, and θ is the angle formed between the irradiation laser and the oscillation direction of the target. When the oscillation direction of the target is in the same direction as the irradiation laser, that is, when θ=0, the distance error due to the Doppler shift is as shown in Equation (1) and Equation (2) to Equation (4).

$$\begin{matrix}[ Equation 4 ] & \\ Δ L = \frac{cT}{2 Δν} Δ f = \frac{Tv}{Δ ν} V & ( 4 )\end{matrix}$$

According to Equation (4), a distance error proportional to the speed of the target is obtained.

On the other hand, a method of reducing the distance errors due to the Doppler shift has been considered in the related art. FIG. 4 is a diagram showing a method of reducing distance errors due to the Doppler shift in the related art. As shown in FIG. 4, the Doppler shift receiving direction is reversed in the upward region (time 0 to T) and downward region (time T to 2T) of the frequency sweep. For this reason, as shown in Equation (5), it is possible to obtain an accurate distance by excluding the influence of the Doppler shift from the beat frequency obtained in the upward region and beat frequency obtained in the downward region.

$$\begin{matrix}[ Equation 5 ] & \\ L = \frac{cT}{2 Δ ν} [ \frac{( {f}_{beat} + Δ f ) + ( {f}_{beat} - Δ f )}{2} ] & ( 5 )\end{matrix}$$

However, in a case where the oscillation frequency is equivalent to the laser frequency sweep cycle, the Doppler shift amounts do not become equal in the upward region and the downward region, so that errors remain. In response to such a problem, in PTL 1, light irradiated from a light source for measurement is branched into two light beams, and the two light beams whose phases of the frequency sweep cycles are shifted by a half cycle are simultaneously irradiated to the target. As a result, light in the upward region and the downward region of the frequency sweep is irradiated at the same time, and the distance errors due to the Doppler shift is reduced regardless of the oscillation frequency of the target. However, a normal frequency sweep cycle is about 1 kHz, and in order to shift the phase by a half cycle, it is necessary to make the optical path difference of two branched light beams be about 100 km. That is, if an optical path difference is provided in the optical fiber, an optical fiber having a length of 100 km is required. In this case, the scale of the apparatus is too large and usability is not good.

In addition, in PTL 2, two orthogonal light sources of polarized light whose phases of the frequency sweep cycles are shifted by a half cycle are provided, multiplexed by a polarization beam splitter, irradiated to the measurement target, the scattered light from the measurement target is separated again by the polarization beam splitter to be detected, thereby reducing the distance errors due to the Doppler shift from the respective beat frequencies by Equation (5). However, in a case where the polarized light is disturbed by the target, there is a possibility that scattered light may not be detected.

The present disclosure has been made in view of such a situation and provides a technique that enables measuring a distance of a target object with high accuracy.

### Solution to Problem

In order to solve the above problem, for example, the configuration described in the claims is adopted. The present disclosure includes a plurality of means for solving the above-mentioned problem, but one example the present disclosure is a distance measuring apparatus that measures a distance from a light source to a measurement target and includes a light source unit that emits a plurality of light beams having different wavelengths, an irradiation optical element that irradiates a measurement target with the emitted light beams, a light receiving unit that receives the light reflected by the measurement target, and a processor that calculates the distance from the light source to the measurement target from the signal detected by the light receiving element. Then, the processor executes frequency calculation processing of calculating a peak frequency corresponding to each wavelength from the signal detected by the light receiving unit and distance calculation processing of reducing the Doppler shift errors caused by the oscillation of the measurement target from the peak frequency corresponding to each wavelength to calculate the distance.

Further features relating to the present disclosure will become apparent from the description of this specification and the accompanying drawings. In addition, aspects of the present disclosure are achieved and realized by combinations of elements and combinations of various elements and the following detailed description and appended claims. It is necessary to understand that the description herein is merely exemplary in nature and is in no way intended to limit the scope or application of the disclosure in any way whatsoever.

### Advantageous Effects of Invention

According to the distance measuring apparatus of the present disclosure, it is possible to measure a distance of a target object with high accuracy.

### BRIEF DESCRIPTION OF DRAWINGS

FIG. 1 is a diagram showing one configuration example of an FMCW method.

FIG. 2 is a diagram showing an example of a beat signal 301 observed by a light receiver.

FIG. 3 is a diagram showing a principle of distance measurement.

FIG. 4 is a diagram showing a method of reducing distance errors due to the Doppler shift in the related art.

FIG. 5 is a diagram showing a schematic configuration of a distance measuring apparatus 1 according to a first embodiment of the present disclosure.

FIG. 6 is a diagram showing an example of a signal (detection signal) detected in the distance measuring apparatus according to the first embodiment.

FIG. 7 is a flowchart for explaining processing of calculating a distance from a detection signal (distance calculation processing).

FIG. 8 is a diagram showing a schematic configuration example of a distance measuring apparatus 2 according to a second embodiment.

FIG. 9 is a diagram showing a schematic configuration example of a distance measuring apparatus 3 according to a third embodiment.

FIG. 10 is a diagram showing an internal configuration example of a feedback mechanism 902.

FIG. 11 is a diagram showing a schematic configuration example of a distance measuring apparatus 4 according to a fourth embodiment.

FIG. 12 is a diagram showing an example of a beat frequency detected by a light receiver 1109.

FIG. 13 is a flowchart for explaining processing of calculating a distance from a detection signal (distance calculation processing).

FIG. 14 is a diagram showing a schematic configuration example of a distance measuring apparatus 5 according to a fifth embodiment.

FIG. 15 is a diagram showing a schematic configuration example of a distance measuring apparatus 6 according to a sixth embodiment.

FIG. 16 is a diagram showing a schematic configuration example of a shape measuring apparatus 7 according to a seventh embodiment, which includes a distance measuring apparatus according to any one of the first to sixth embodiments.

FIG. 17 is a flowchart for describing shape measuring processing according to the seventh embodiment.

FIG. 18 is a diagram showing a schematic configuration example of an inner diameter measuring apparatus 8 according to an eighth embodiment, which includes a distance measuring apparatus according to any one of the first to sixth embodiments.

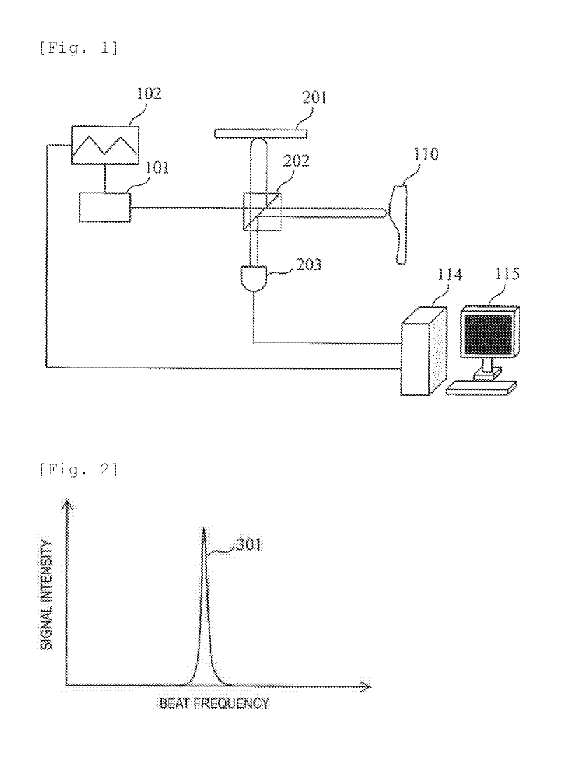

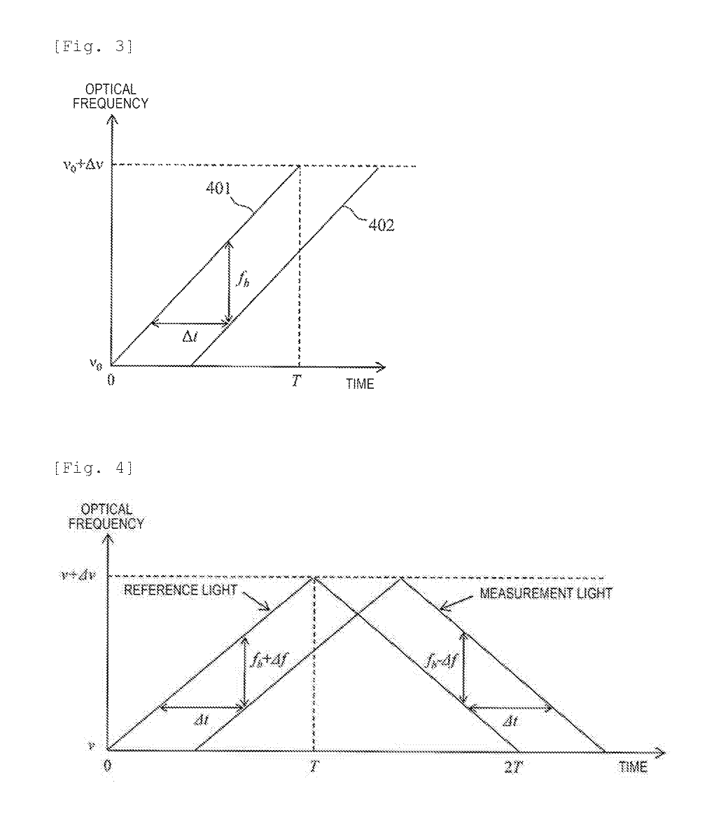

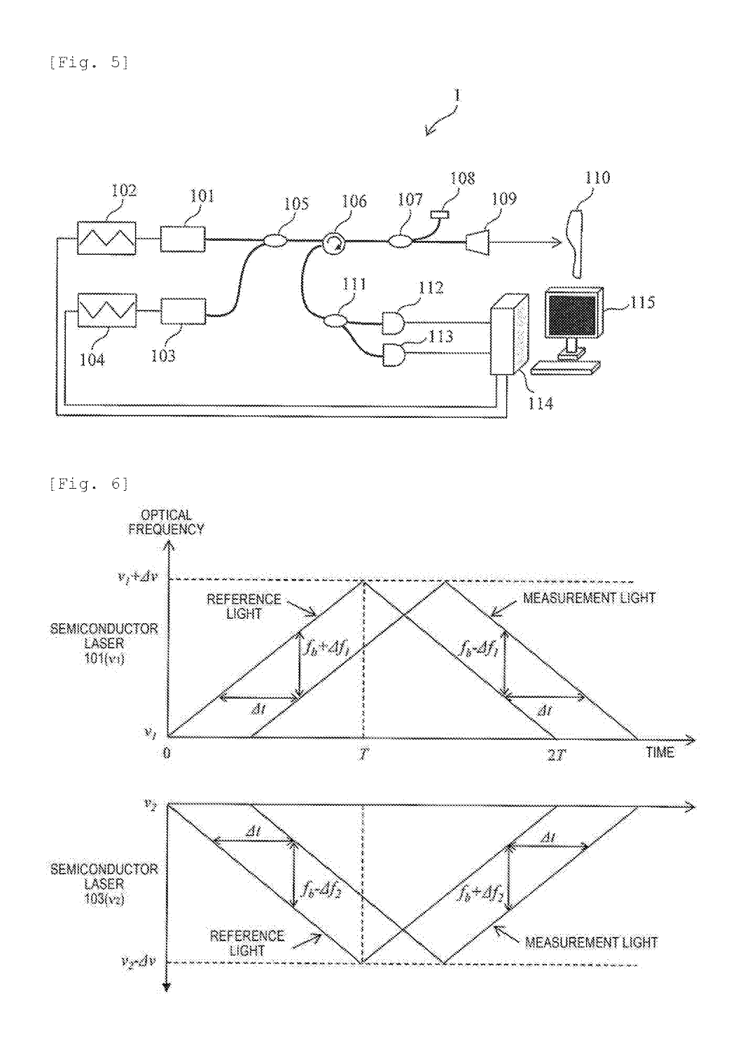

### DESCRIPTION OF EMBODIMENTS

Embodiments of the present disclosure disclose a technique that reduces the scale of a distance measuring apparatus and enables measuring a distance of a target object with high accuracy.

The distance measuring apparatus according to the present embodiment executes frequency calculation processing of calculating a peak frequency corresponding to light of each wavelength emitted from a light source unit from a signal detected by a light receiving unit and distance calculation processing of reducing the Doppler shift errors caused by the oscillation of a measurement target from the peak frequency corresponding to the light of each wavelength and calculating the distance. In addition, the light source unit of the distance measuring apparatus is configured to output a plurality of light beams by sweeping optical frequencies so that the frequency sweep cycles of a plurality of light beams having different wavelengths are shifted by a predetermined cycle. In the present embodiment, more specifically, the Doppler shift errors may be reduced and the distance L may be calculated based on the following equation.

$$L = \frac{cT}{2 Δ ν} \cdot \frac{{ν}_{1} {ν}_{2}}{{ν}_{1} + {ν}_{2}} [ \frac{1}{{ν}_{1}} ( {f}_{beat} + Δ {f}_{1} ) + \frac{1}{{ν}_{2}} ( {f}_{beat} - Δ {f}_{2} ) ]$$

Here, T is a modulation cycle, Δν is a frequency sweep width, and ν1 and ν2 are wavelengths (in a case where two light beams are used). In addition, Δt is a time difference between the reference light and the light reflected by the measurement target, Δf1 and Δf2 are the Doppler shift amounts of the respective light beams, and f_{beat} is a beat frequency.

Hereinafter, embodiments of the present disclosure will be described with reference to the accompanying drawings. In the accompanying drawings, the same functional elements may be represented by the same numbers. The accompanying drawings illustrate specific embodiments and implementations consistent with the principles of the disclosure, but the accompanying drawings are for an understanding of the present disclosure and are not used to limit interpretation of the present disclosure in any way.

In the present embodiment, those skilled in the art have explained the embodiment in sufficient detail to implement the present disclosure, but it is necessary to understand that other implementations and configurations are possible and it is possible to change the configuration and structure and replace various elements without departing from the scope and spirit of the technical idea of the present disclosure. Therefore, the following description should not be limited and interpreted thereto.

### (1) First Embodiment

### <Configuration of Distance Measuring Apparatus>

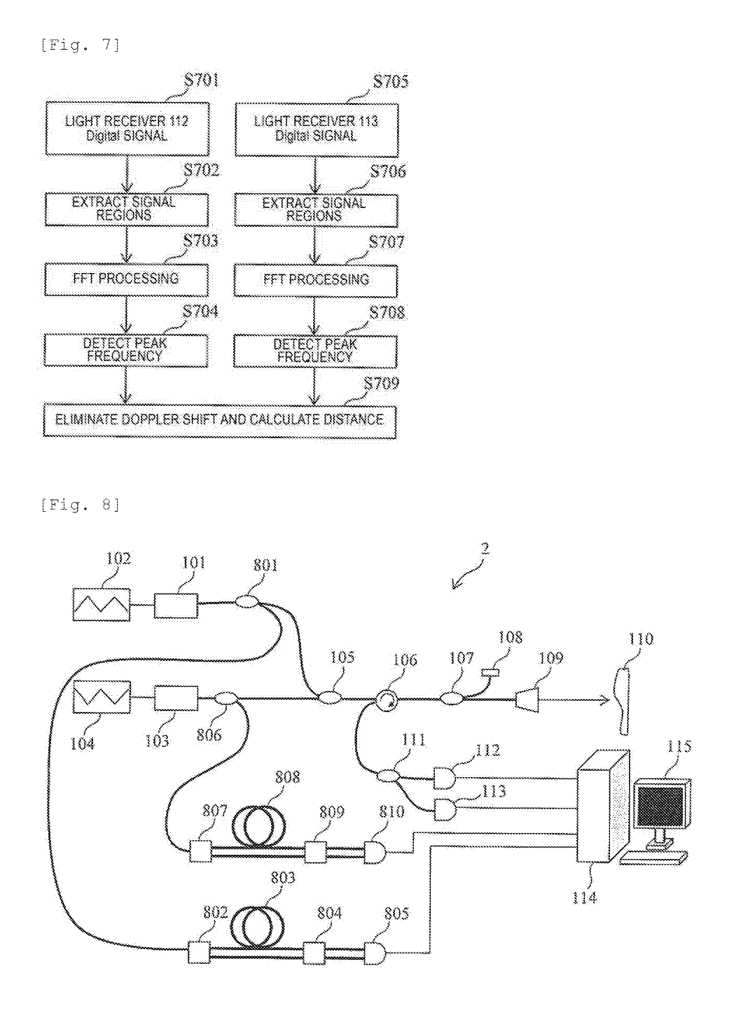

FIG. 5 is a diagram showing a schematic configuration of the distance measuring apparatus 1 according to a first embodiment of the present disclosure. The distance measuring apparatus 1 includes semiconductor lasers 101 and 103, arbitrary signal generators 102 and 104, a fiber coupler 105, a circulator 106, a fiber coupler 107, a reference mirror 108, a collimator lens (for example, a fiber collimator) 109, a fiber coupler 111, light receivers 112 and 113, a computer (PC) 114, and a monitor 115.

The PC 114 transmits a sweep waveform signal to the arbitrary signal generator 102. The arbitrary signal generator 102 modulates the driving current of the semiconductor laser 101, thereby sweeping the optical frequency. Similarly, the PC 114 transmits a sweep waveform signal to the arbitrary signal generator 104. The arbitrary signal generator 104 modulates the driving current of the semiconductor laser 103, thereby sweeping the optical frequency. Here, the frequency of the semiconductor laser 101 is denoted by ν1, the frequency of the semiconductor laser 103 is denoted by ν2, and the frequencies of ν1 and ν2 are different (that is, laser wavelengths are different).

The light irradiated from the semiconductor lasers 101 and 103 is multiplexed by the fiber coupler 105. The multiplexed light passes through the circulator 106 and is branched by the fiber coupler 107. A part of the branched light is reflected by the reference mirror 108 and becomes reference light. Most of the rest of the branched light is irradiated onto space by the collimator lens 109 and irradiated to the measurement target (also referred to as observation target) 110. The light reflected from the measurement target 110 again passes through the collimator lens 109 and joins with the reference light from the reference mirror 108 at the fiber coupler 107 portion, and then is guided to the fiber coupler 111 by the circulator 106 and the wavelength thereof is separated by the fiber coupler 111.

The light whose wavelength is separated is detected by the light receiver 112 for the semiconductor laser 101 and the light receiver 113 for the semiconductor laser 103, respectively. Each of the light receivers 112 and 113 generates a beat signal by interference between the reference light and the measurement light.

<Detection Signal Example and Distance Calculation Processing>

FIG. 6 is a diagram showing an example of a signal (detection signal) detected in the distance measuring apparatus according to the first embodiment.

As shown in FIG. 6, since the phase of the optical frequency sweep of the semiconductor laser 101 and the phase of the optical frequency sweep of the semiconductor laser 103 are shifted by a half cycle, the influence of the Doppler shift is reversed. Therefore, by using the signals of the upward region and the downward region of the sweep, the influence of the Doppler shift is canceled.

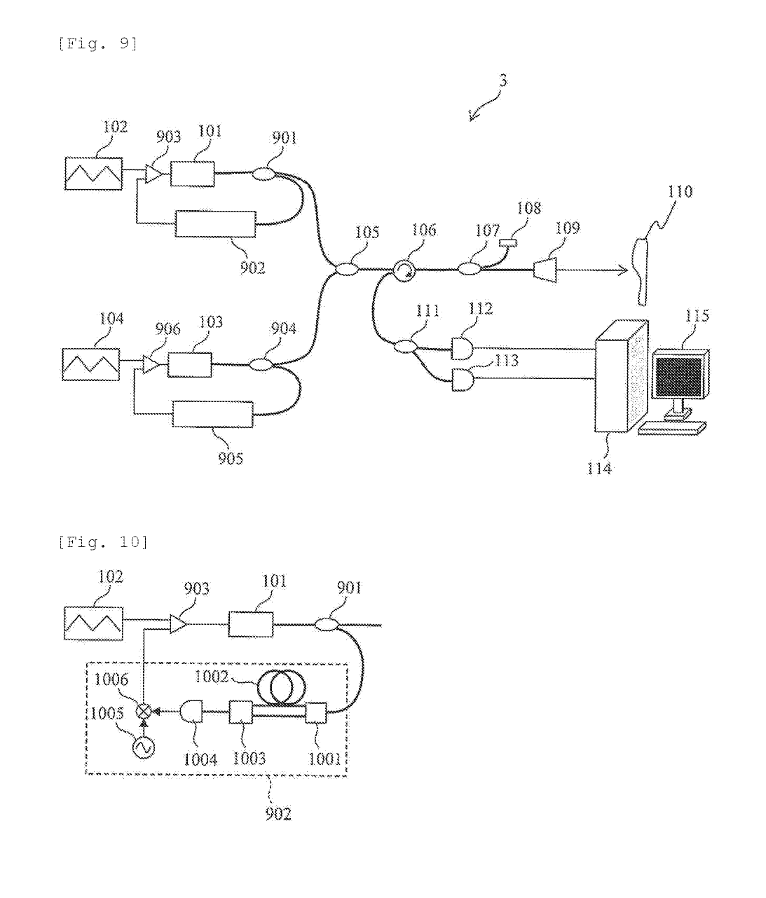

FIG. 7 is a flowchart for explaining processing of calculating a distance from a detection signal (distance calculation processing). The distance calculation processing is executed by a processor (CPU or MPU) included in the computer 114. More specifically, a program (distance calculation program) for executing the distance calculation processing according to FIG. 7 is stored in a memory (not shown) of the computer 114, and the processor reads the distance calculation program from the memory to execute the program. Hereinafter, a processor of the computer 114 (hereinafter, simply referred to as “processor”) will be described as an operation subject.

(i) Step 701

The processor performs A/D conversion on the signal detected by the light receiver 112 to acquire a digital signal.

(ii) Step 702

In the detected digital signal, the processor extracts the signals in the upward region of the frequency sweep.

(iii) Step 703

The processor performs FFT processing on the signals extracted in step 702.

(iv) Step 704

The processor detects the peak frequency from the FFT-processed signal in step 703.

(v) Step 705

Similarly, the processor performs A/D conversion on the signal detected by the light receiver 113 to acquire a digital signal.

(vi) Step 706

The processor extracts the signals in the upward region of the frequency sweep in the detected digital signals.

(vii) Step 707

The processor performs FFT processing on the signals extracted in step 706.

(ix) Step 708

The processor detects the peak frequency from the FFT-processed signal in step 707.

(x) Step 709

The processor eliminates the Doppler shift from the peak frequencies obtained in steps 704 and 708 and calculates an accurate distance. The processing details of step 709 are as follows. In a case where the measurement target oscillates, the amount of Doppler shift received by the semiconductor laser 101 is expressed by Equation (6).

$$\begin{matrix}[ Equation 6 ] & \\ Δ {f}_{1} = {ν}_{1} \frac{2 V}{c} & ( 6 )\end{matrix}$$

In addition, the amount of Doppler shift received by the semiconductor laser 103 is expressed by Equation (7).

$$\begin{matrix}[ Equation 7 ] & \\ Δ {f}_{2} = {ν}_{2} \frac{2 V}{c} & ( 7 )\end{matrix}$$

When comparing Equations (6) and (7), since the wavelengths ν1 and ν2 of the laser are different, the Doppler shift amounts Δf 1 and Δf 2 are also different. Therefore, in the case of calculating the distance by using Equation (5) as it is, an error occurs. Therefore, by using Equation (8), it is possible to obtain an accurate distance without an error.

$$\begin{matrix}[ Equation 8 ] & \\ L = \frac{cT}{2 Δν} \cdot \frac{{ν}_{1} {ν}_{2}}{{ν}_{1} + {ν}_{2}} [ \frac{1}{{ν}_{1}} ( {f}_{beat} + Δ {f}_{1} ) + \frac{1}{{ν}_{2}} ( {f}_{beat} - Δ {f}_{2} ) ] & ( 8 )\end{matrix}$$

As described above, it is possible to calculate the distance to the measurement target from which the distance error due to the Doppler shift has been eliminated.

In FIG. 7, the processing of steps 701 to 704 and the processing of steps 705 to 708 are shown to be performed in parallel, but the execution order of each step may be arbitrarily set.

### (2) Second Embodiment

In order to accurately measure the distance L from the above Equation (2), the beat frequency f_{b} needs to be constant during the modulation cycle T. However, as the characteristic of the semiconductor laser, since the change amount of the optical frequency with respect to the change amount of an injection current is nonlinear, the measurement accuracy deteriorates. Therefore, in the second embodiment, a distance measuring apparatus that performs correction using a reference interferometer having a constant optical path difference is proposed.

<Configuration of Distance Measuring Apparatus>

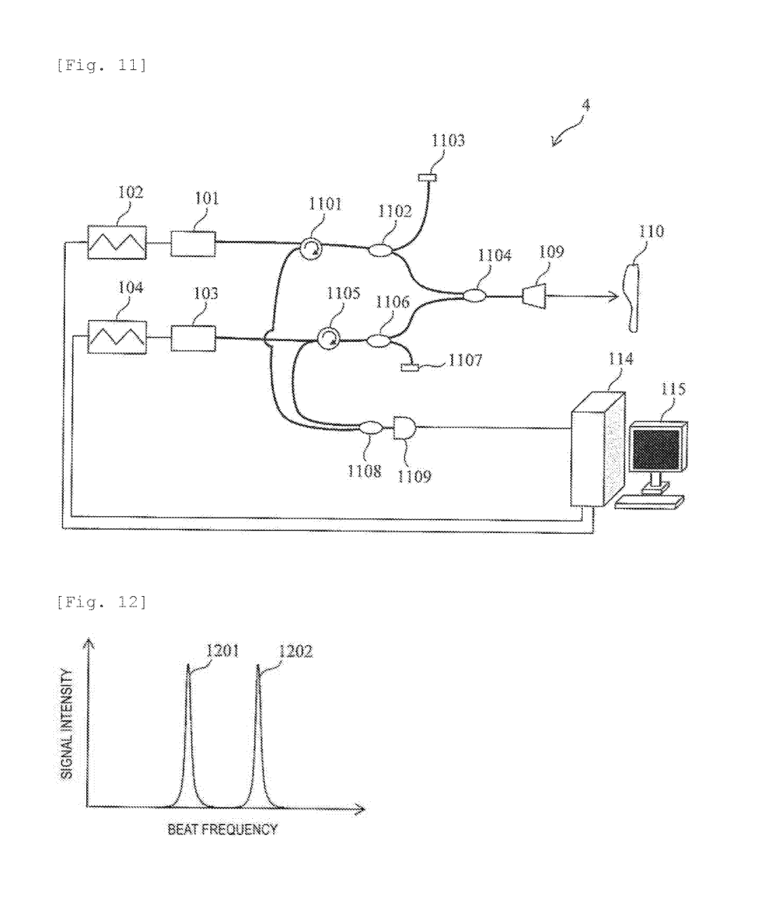

FIG. 8 is a diagram showing a schematic configuration example of the distance measuring apparatus 2 according to the second embodiment. The distance measuring apparatus 2 of FIG. 8 has almost the same configuration as the distance measuring apparatus 1 of FIG. 5 in most cases. The difference is that light irradiated from a semiconductor laser is branched by a fiber coupler and a part thereof is guided to a reference interferometer.

The light irradiated from the semiconductor laser 101 is branched by the fiber coupler 801. A part of the branched light is guided to a fiber coupler 802. After the light is further branched into two by the fiber coupler 802 and a certain optical path difference is provided by an optical fiber 803, the light is configured to be multiplexed again by a fiber coupler 804 and received by a light receiver 805. This is the configuration of the Mach-Zehnder interferometer, and a constant beat signal proportional to the optical path difference is generated in the light receiver 805. Using this beat signal as a sampling clock, by sampling the light detected by the light receiver 112, nonlinear influence may be suppressed.

Similarly, the light irradiated from the semiconductor laser 103 is branched by the fiber coupler 806. Apart of the branched light is guided to the fiber coupler 807. After the light is further branched into two by the fiber coupler 807 and a certain optical path difference is provided by an optical fiber 808, the light is configured to be multiplexed again by a fiber coupler 809 and received by a light receiver 810. This is the configuration of the Mach-Zehnder interferometer, and a constant beat signal proportional to the optical path difference is generated in the light receiver 810. Using this beat signal as a sampling clock, by sampling the light detected by the light receiver 113, nonlinear influence may be suppressed. Then, by performing the same processing as the processing described in the first embodiment, the distance may be measured with high accuracy.

### (3) Third Embodiment

In order to accurately measure the distance L from the above Equation (2), the beat frequency f_{b} needs to be constant during the modulation cycle T. However, as the characteristic of the semiconductor laser, since the change amount of the optical frequency with respect to the change amount of an injection current is nonlinear, the measurement accuracy deteriorates. Therefore, in the third embodiment, a distance measuring apparatus that controls an injection current of a semiconductor laser to keep a beat frequency constant is proposed.

<Configuration of Distance Measuring Apparatus>

FIG. 9 is a diagram showing a schematic configuration example of the distance measuring apparatus 3 according to the third embodiment. The distance measuring apparatus 3 of FIG. 9 has almost the same configuration as the distance measuring apparatus 1 of FIG. 5 in most cases. The difference is that light irradiated from a semiconductor laser is branched by a fiber coupler 901 and a part thereof is guided to a feedback mechanism for controlling the injection current of the semiconductor laser 101. The light irradiated from the semiconductor laser 101 is branched by the fiber coupler 901. Apart of the branched light is guided to a feedback mechanism (feedback circuit) 902.

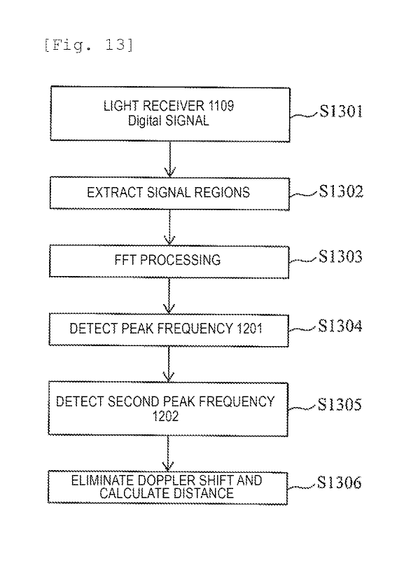

FIG. 10 is a diagram showing an internal configuration example of a feedback mechanism 902. In FIG. 10, after the light from the fiber coupler 901 is further branched into two by a fiber coupler 1001 and a certain optical path difference is provided by an optical fiber 1002, the light is configured to be multiplexed again by a fiber coupler 1003 and received by a light receiver 1004. This is the configuration of the Mach-Zehnder interferometer, and a constant beat signal proportional to the optical path difference is generated in the light receiver 1004. The beat signal is controlled to be constant by mixing the beat signal and the signal from the signal oscillator 1005 in a mixer 1006 and adding a current signal corresponding to the difference frequency or the difference phase to the current signal from the arbitrary signal generator 102 by a combiner 903.

Similarly, the light irradiated from the semiconductor laser 103 is branched by the fiber coupler 904. Apart of the branched light is guided to the feedback mechanism 905. The feedback mechanism 905 has the same configuration as the feedback mechanism 902 (see FIG. 10), and the beat signal is controlled to be constant by adding the current signal to be output to the current signal from the arbitrary signal generator 104 by the combiner 906.

In this way, by using the two light sources whose frequencies are linearly swept and performing the same processing as described in the first embodiment, the distance may be measured with high accuracy.

### (4) Fourth Embodiment

### <Configuration of Distance Measuring Apparatus 4>

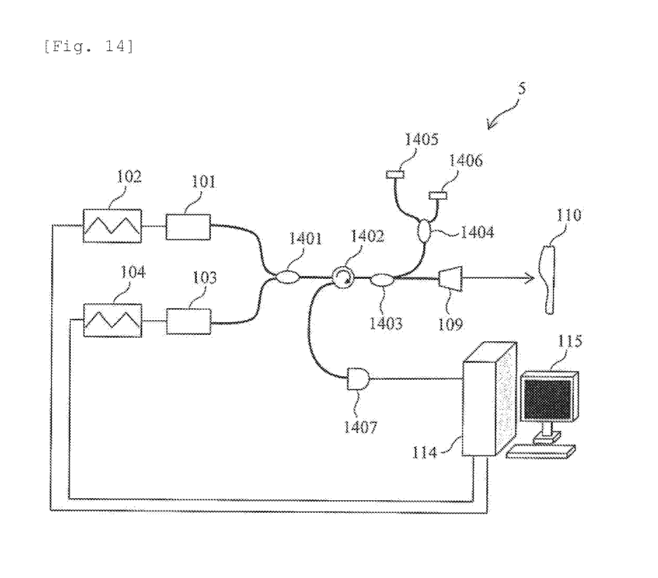

FIG. 11 is a diagram showing a schematic configuration example of the distance measuring apparatus 4 according to a fourth embodiment. In the distance measuring apparatus 4, there is one light receiver, which is different from the distance measuring apparatus 1 (see FIG. 5) having two light receivers.

The computer (PC) 114 transmits a sweep waveform signal to the arbitrary signal generator 102. The arbitrary signal generator 102 sweeps the optical frequency by modulating the driving current of the semiconductor laser 101. The light emitted from the laser passes through the circulator 1101 and is branched by a fiber coupler 1102 and a part thereof is reflected by a reference mirror 1103 to become reference light and most of the rest is guided to a WDM coupler 1104.

Similarly, the computer (PC) 114 transmits a sweep waveform signal to the arbitrary signal generator 104. The arbitrary signal generator 104 sweeps the optical frequency by modulating the driving current of the semiconductor laser 103. The light emitted from the laser passes through a circulator 1105 and is branched by a fiber coupler 1106 and apart thereof is reflected by a reference mirror 1107 to become reference light and most of the rest is guided to the WDM coupler 1104.

The light multiplexed by the WDM coupler 1104 is irradiated into space by the collimator lens (fiber collimator) 109 and irradiated to the measurement target 110. The light reflected from the measurement target 110 again passes through the collimator lens 109, is guided to the WDM coupler 1104, and the wavelength thereof is separated by the WDM coupler 1104. A part of the light obtained by wavelength separation by the WDM coupler 1104 passes through the fiber coupler 1102 and the circulator 1101 again and is guided to the WDM coupler 1108. Similarly, the other light obtained by wavelength separation by the WDM coupler 1104 passes through the fiber coupler 1106 and the circulator 1105 again and is guided to the WDM coupler 1108.

The light multiplexed by the WDM coupler 1108 is detected by the light receiver 1109 and generates a beat signal by interference between the reference light and the measurement light. At this time, by giving a difference between the distance from the fiber coupler 1102 to the reference mirror 1103 and the distance from the fiber coupler 1106 to the reference mirror 1107, even if the same measurement target is measured, since the distance to the reference mirror is different, beat signals may be generated at different positions.

<Detected Signal Example and Distance Calculation Processing>

FIG. 12 is a diagram showing an example of a beat frequency detected by the light receiver 1109. In FIG. 12, a peak frequency (beat signal detected by a light receiver) 1201 having a low beat frequency indicates a beat frequency corresponding to the semiconductor laser 101 having a small distance difference between the measurement target and the reference mirror. On the other hand, a peak frequency (beat signal detected by a light receiver) 1202 having a high beat frequency indicates a beat frequency corresponding to the semiconductor laser 103 having a large distance difference between the measurement target and the reference mirror. By detecting these two beat frequencies, it is possible to accurately calculate the distance to the measurement target based on Equation (8) above.

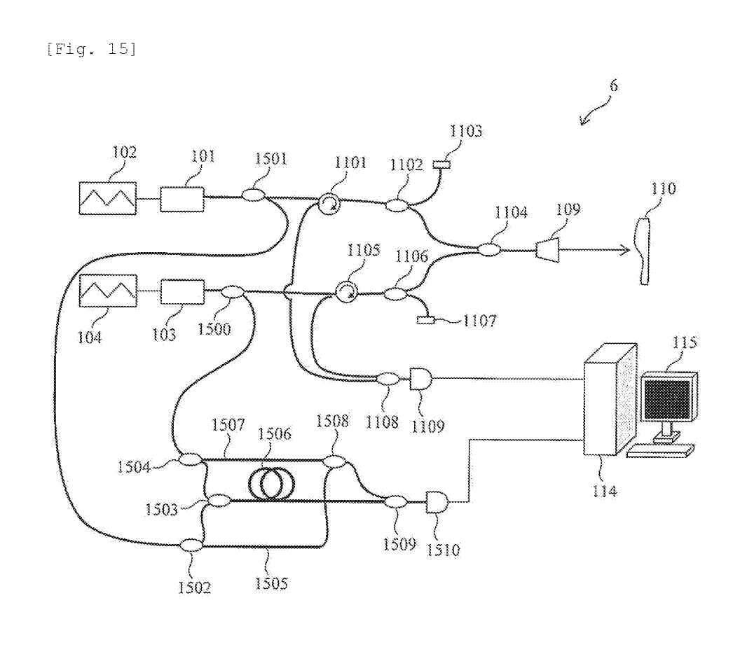

FIG. 13 is a flowchart for explaining processing of calculating a distance from a detection signal (distance calculation processing). The distance calculation processing is executed by a processor (CPU or MPU) included in the computer 114. More specifically, a program (distance calculation program) for executing the distance calculation processing according to FIG. 7 is stored in a memory (not shown) of the computer 114, and the processor reads the distance calculation program from the memory to execute the program. Hereinafter, a processor of the computer 114 (hereinafter, simply referred to as “processor”) will be described as an operation subject.

(i) Step 1301

The processor performs A/D conversion on the signal detected by the light receiver 1109 to acquire a digital signal.

(ii) Step 1302

The processor extracts signals of a region corresponding to a half cycle of the frequency sweep cycle out of the detected digital signals obtained in step 1301.

(iii) Step 1303

The processor performs FFT processing on the signals extracted in step 1302.

(iv) Step 1304

The processor detects the lower frequency peak frequency from the FFT processed-signal in step 1303.

(v) Step 1305

The processor detects the higher frequency peak frequency from the FFT processed-signal in step 1303. The execution order of steps 1304 and 1305 may be reversed.

(vi) Step 1306

From the two peak frequencies detected in steps 1304 and 1305, the processor may calculate an accurate distance by eliminating the Doppler shift based on Equation (8).

### (5) Fifth Embodiment

### <Configuration of Distance Measuring Apparatus>

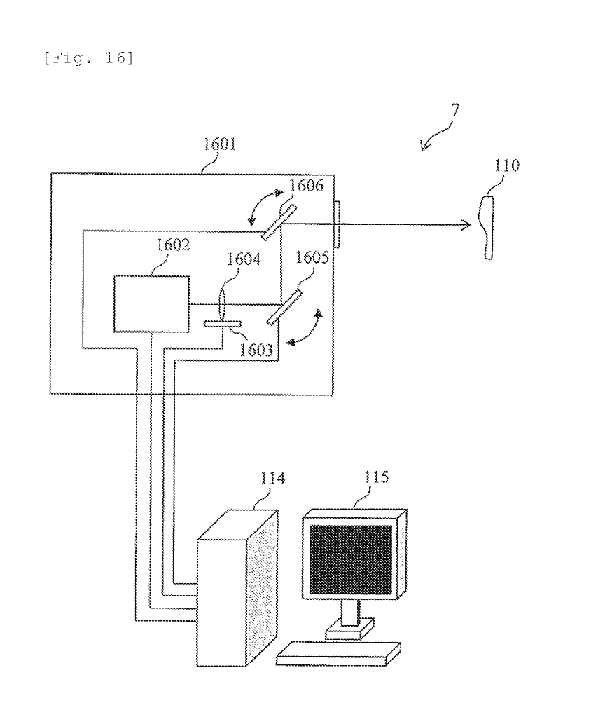

FIG. 14 is a diagram showing a schematic configuration example of the distance measuring apparatus 4 according to a fifth embodiment. As with the distance measuring apparatus 4, the distance measuring apparatus 5 is configured to have one light receiver.

The computer (PC) 114 transmits a sweep waveform signal to the arbitrary signal generator 102. The arbitrary signal generator 102 sweeps the optical frequency by modulating the driving current of the semiconductor laser 101.

Similarly, the computer (PC) 114 transmits a sweep waveform signal to the arbitrary signal generator 104. The arbitrary signal generator 104 sweeps the optical frequency by modulating the driving current of the semiconductor laser 103.

The light output from the semiconductor laser 101 and the semiconductor laser 103 is multiplexed by the WDM coupler 1401. The light multiplexed by the WDM coupler 1401 passes through the circulator 1402 and is branched by the fiber coupler 1403. One of the light beams obtained by branching is further branched by a WDM coupler 1404 and reflected by a reference mirror 1405 for the semiconductor laser 101 and a reference mirror 1406 for the semiconductor laser 103 to become reference light.

The other light (most of the light) obtained by branching is irradiated to space by the collimator lens 109 and irradiated to the measurement target 110. The light reflected from the measurement target 110 passes through the collimator lens 109 again, is multiplexed with the reference light from the reference mirrors 1405 and 1406 by the fiber coupler 1403, and then passes through the circulator 1402.

The light that has passed through the circulator 1402 is detected by the light receiver 1407, and a beat signal is generated by interference between the reference light and the measurement light. At this time, by giving a difference between the distance from the WDM coupler 1404 to the reference mirror 1405 and the distance from the WDM coupler 1404 to the reference mirror 1406, even if the same measurement target is measured, since the distance to the reference mirror is different, beat signals may be generated at different positions. The processing contents after this are the same as those in the fourth embodiment.

### (6) Sixth Embodiment

In order to accurately measure the distance L from the above Equation (2), the beat frequency f_{b} needs to be constant during the modulation cycle T. However, as the characteristic of the semiconductor laser, since the change amount of the optical frequency with respect to the change amount of an injection current is nonlinear, the measurement accuracy deteriorates. Therefore, in the sixth embodiment, a distance measuring apparatus that performs correction using a reference interferometer having a constant optical path difference is proposed.

<Configuration of Distance Measuring Apparatus>

FIG. 15 is a diagram showing a schematic configuration example of the distance measuring apparatus 6 according to a sixth embodiment. The distance measuring apparatus 6 of FIG. 15 has almost the same configuration as the distance measuring apparatus 4 of FIG. 11 in most cases. The difference is that light irradiated from a semiconductor laser is branched by a fiber coupler and a part thereof is guided to a reference interferometer.

The light output from the semiconductor laser 101 is branched by a fiber coupler 1501. Apart of the branched light is guided to a fiber coupler 1502 and further branched into two by the fiber coupler 1502. A part of the light further branched by the fiber coupler 1502 is guided to the optical fiber 1505. The other light further branched by the fiber coupler 1502 passes through a WDM coupler 1503, is guided to the optical fiber 1506, and has a constant optical path difference. Thereafter, the light that has passed through the optical fiber 1505 passes through a WDM coupler 1508, is multiplexed by a fiber coupler 1509, and is received by a light receiver 1510. This is the configuration of the Mach-Zehnder interferometer, and a constant beat signal proportional to the optical path difference between the optical fiber 1505 and the optical fiber 1506 is generated in the light receiver 1510.

Similarly, the light output from the semiconductor laser 103 is branched by a fiber coupler 1500. A part of the branched light is guided to a fiber coupler 1504 and further branched into two by the fiber coupler 1504. A part of the light further branched by the fiber coupler 1504 is guided to the optical fiber 1507. The other light further branched by the fiber coupler 1504 passes through a WDM coupler 1503, is guided to the optical fiber 1506, and has a constant optical path difference. Thereafter, the light that has passed through the optical fiber 1507 passes through a WDM coupler 1508, is multiplexed by a fiber coupler 1509, and is received by a light receiver 1510. This is the configuration of the Mach-Zehnder interferometer, and a constant beat signal proportional to the optical path difference between the optical fiber 1506 and the optical fiber 1507 is generated in the light receiver 1510.

In FIG. 15, since the lengths of the optical fiber 1505 and the optical fiber 1507 are different, two beat signals are generated. By extracting a low-frequency beat signal among the beat signals by a filter and sampling the light detected by the light receiver 1109 as a sampling clock, it is possible to suppress the nonlinear effect. Similarly, by extracting a high-frequency beat signal among the beat signals detected by the light receiver 1510 by a filter and sampling the light detected by the light receiver 1109 as a sampling clock, it is possible to suppress the nonlinear influence. Other processing contents are the same as those in the fourth embodiment.

### (7) Seventh Embodiment

The seventh embodiment relates to a shape measuring apparatus that measures the shape of a measurement target by using any one of the distance measuring apparatus 1 to 6 according to the first to sixth embodiments.

<Configuration of Shape Measuring Apparatus>

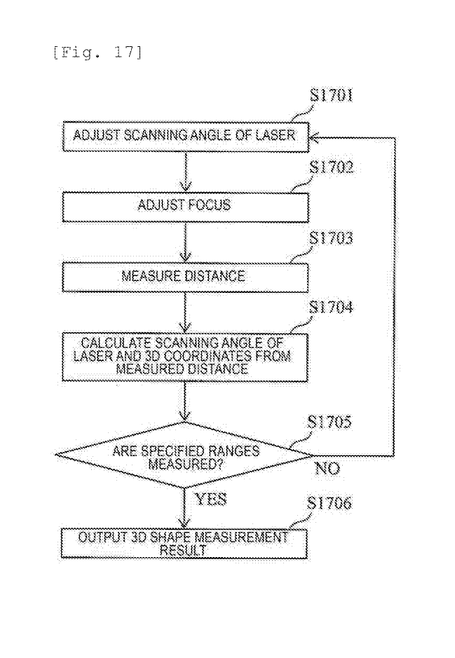

FIG. 16 is a diagram showing a schematic configuration example of the shape measuring apparatus 7 according to a seventh embodiment, which includes a distance measuring apparatus according to any one of the first to sixth embodiments. The shape measuring apparatus 7 includes a 3D shape measuring unit 1601, a computer (PC) 114, and a monitor 115.

The 3D shape measuring unit 1601 measures the 3D shape of the measurement target 110 and includes a distance measurement unit (distance measuring apparatus) 1602 according to any one of the first to sixth embodiments, a one-axis stage 1603, a focus lens 1604, and galvanometer mirrors 1605 and 1606.

By driving the one-axis stage 1603 on which the focus lens 1604 is mounted, laser light irradiated from the collimator lens 109 of the distance measurement unit 1602 is focused on the measurement target 110 for adjustment. In addition, by swinging the galvanometer mirrors 1605 and 1606, the measurement surface of the measurement target 110 is scanned two-dimensionally with laser light, and the shape of the measurement target 110 is measured.

<Shape Measurement Processing>

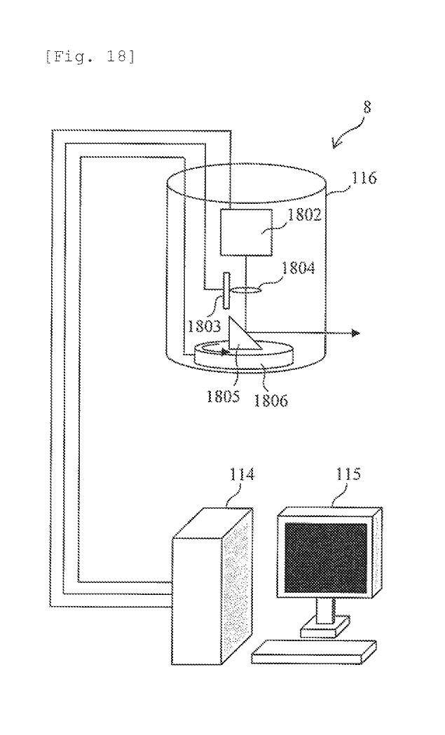

FIG. 17 is a flowchart for describing shape measuring processing according to a seventh embodiment. The shape measurement processing is executed by a processor (CPU or MPU) included in the computer 114. More specifically, a program (shape measurement program) for executing the shape measurement processing according to FIG. 17 is stored in a memory (not shown) of the computer 114, and the processor reads the distance calculation program from the memory to execute the program. Hereinafter, a processor of the computer 114 (hereinafter, simply referred to as “processor”) will be described as an operation subject.

(i) Step 1701

The processor adjusts a scanning angle of the laser output from the distance measurement unit 1602 based on the information of a certain coordinate point in an input specified range (for example, a user inputs the size of the measurement target 110).

(ii) Step 1702

The processor moves the one-axis stage 1603 in the axial direction to focus the one-axis stage on the measurement target 110 (focus adjustment).

(iii) Step 1703

The processor executes the processing described in the distance measuring apparatus according to the first to sixth embodiments and measures the distance to the measurement target 110.

(iv) Step 1704

The processor calculates the 3D coordinates of the measurement target 110 from the scanning angle of the laser determined in step 1701 and the distance measured in step 1703.

(v) Step 1705

The processor determines whether or not all the input specified ranges have been measured. When all the specified ranges (all coordinate points) have been measured (YES in step 1705), the processing proceeds to step 1706. If all the specified ranges have not been measured yet (NO in step 1705), the processing proceeds to step 1701.

(vi) Step 1706

The processor outputs the 3D shape measurement result of all coordinate points in the specified range.

### (8) Eighth Embodiment

FIG. 18 is a diagram showing a schematic configuration example of an inner diameter measuring apparatus 8 according to an eighth embodiment, which includes a distance measuring apparatus according to any one of the first to sixth embodiments.

The inner diameter measuring apparatus 8 is an apparatus that measures the inner diameter of an inner diameter measurement target 116 and includes a distance measuring unit (distance measuring apparatus) 1802 according to any one of the first to sixth embodiments, a one-axis stage 1803, a focus lens 1804, a reflecting prism 1805, a rotary stage 1806, a computer (PC) 114, and a monitor 115.

By driving the one-axis stage 1803 on which the focus lens 1804 is mounted, laser light irradiated from the collimator lens 109 of the distance measurement unit 1802 is focused on the inner side surface of the inner diameter measurement target 116 for adjustment. In addition, by rotating the reflecting prism 1805 mounted on the rotary stage 1806 and reflecting the laser light at a right angle by the reflecting prism 1805, it is possible to measure the inner diameter of the inner diameter measurement target 116.

### (9) Summary

(i) In each of the embodiments, two light sources are provided to emit light beams having different wavelengths, but light beams having different wavelengths may be emitted from one light source. Therefore, a configuration including the semiconductor lasers 101 and 103 and the arbitrary signal generators 102 and 104 may be referred to as a “light source unit”. In addition, two light beams having different wavelengths are used, but three or more light beams having different wavelengths may be used. In this case, three or more light sources may be used, or three or more light beams may be emitted from the light source unit.

(ii) The distance measuring apparatus according to the present embodiment executes frequency calculation processing of calculating a peak frequency corresponding to light of each wavelength emitted from a light source unit from a signal detected by a light receiving unit and distance calculation processing of reducing the Doppler shift errors caused by the oscillation of a measurement target from the peak frequency corresponding to the light of each wavelength and calculating the distance. By doing so, it is possible to measure the distance with high accuracy (the distance from the light source to the measurement target).

In addition, the light source unit of the distance measuring apparatus is configured to output a plurality of light beams by sweeping optical frequencies so that the frequency sweep cycles of a plurality of light beams having different wavelengths are shifted by a predetermined cycle. By doing so, it is unnecessary to provide a very long (for example, 100 km long) optical fiber to provide an optical path difference, and the scale of the distance measuring apparatus may be reduced.

In a case where a plurality of light sources are used in the light source unit, the optical axes of a plurality of emitted light beams are different immediately after emission. For this reason, a multiplexing optical element that multiplexes a plurality of light beams into a plurality of coaxial light beams is provided so that the plurality of coaxial light beams are irradiated on the measurement target. It is possible to irradiate a plurality of light beams having different wavelengths to the same portion of the measurement target with one time of measurement, to improve the throughput of measurement, and further to reduce the measurement errors. As the multiplexing optical element, for example, it is possible to use a WDM coupler or a dichroic mirror.

In addition, a branching optical element that branches a plurality of coaxial lights is provided in the middle of the optical path from the multiplexing optical element to the measurement target. Then, part of the light branched by the branching optical element is guided to the reference mirror. Light other than light guided to the reference mirror is guided to the irradiation optical element and irradiated to the measurement target. Here, for example, a fiber coupler may be used as the branching optical element, and for example, a collimator lens may be used as the irradiation optical element.

In addition, the light receiving unit is configured to receive the light reflected by the measurement target in accordance with the wavelength of the emitted light. By doing so, it is possible to generate a beat signal due to interference between reference light and measurement light (reflected light from the measurement target) for each of the light beams having different wavelengths.

In addition, the distance measuring apparatus of the present disclosure may be provided with a calibration interferometer that reduces errors caused by the nonlinearity of the optical frequency sweep in the light source unit. By doing so, the distance may be measured with higher accuracy.

Furthermore, the distance measuring apparatus according to the present disclosure is provided with a feedback mechanism for generating a signal for controlling the injection current of the light source unit from a part of the light emitted from the light source unit and feeding the signal back to the light source unit. By doing so, the distance may be measured with higher accuracy. In the present embodiment, more specifically, the Doppler shift errors may be reduced and the distance L may be calculated based on the following equation.

$$L = \frac{cT}{2 Δ ν} \cdot \frac{{ν}_{1} {ν}_{2}}{{ν}_{1} + {ν}_{2}} [ \frac{1}{{ν}_{1}} ( {f}_{beat} + Δ {f}_{1} ) + \frac{1}{{ν}_{2}} ( {f}_{beat} - Δ {f}_{2} ) ]$$

Here, T is a modulation cycle, Δν is a frequency sweep width, and ν1 and ν2 are wavelengths (in a case where two light beams are used). In addition, Δt is a time difference between reference light and the light reflected by the measurement target, Δf1 and Δf2 are the Doppler shift amounts of the respective light beams, and f_{beat} is a beat frequency.

(iii) The present embodiment also provides a shape measuring apparatus and an inner diameter measuring apparatus having the above-mentioned distance measuring apparatus. The shape measuring apparatus includes a focusing lens that focuses the light from the distance measuring apparatus to the shape measurement target and a mirror for scanning the focused light on the shape measurement target. Then, the shape measuring apparatus measures the three-dimensional shape of the shape measurement target to output a three-dimensional shape measurement result by using the distance from the light source unit to the shape measurement target measured by the distance measuring apparatus and the scanning angle of the light whose focus is adjusted.

The inner diameter measuring apparatus includes a focus lens that focuses the light from the distance measuring apparatus to the shape measurement target, a rotary stage, and a reflecting prism mounted thereon. While rotating the reflecting prism by the rotary stage, the focused light is reflected at a right angle by the reflecting prism. By doing so, it is possible to measure the inner diameter of the inner diameter measurement target.

(iv) In the present disclosure, the functions executed by the processor may also be realized by the program codes of software. In this case, a storage medium storing the program codes is provided to the system or device, and a computer (or CPU or MPU) of the system or device reads the program codes stored in the storage medium. In this case, the program codes themselves read from the storage medium realizes the functions of the embodiments described above, and thus the program codes themselves and the storage medium storing the program codes constitute the present disclosure. As the storage medium for supplying such program codes, for example, a flexible disk, a CD-ROM, a DVD-ROM, a hard disk, an optical disk, a magneto-optical disk, a CD-R, a magnetic tape, a nonvolatile memory card, a ROM, and the like are used.

In addition, an operating system (OS) or the like running on the computer may perform a part or all of the actual processing based on the instructions of the program codes so that the functions of the above-described embodiments may be realized by the processing. Furthermore, after the program codes read from the storage medium is written in the memory on the computer, the CPU of the computer or the like may perform a part or all of the actual processing based on the instructions of the program codes so that the functions of the above embodiments may be realized by the processing.

Furthermore, by distributing the program codes of the software realizing the functions of the embodiments via a network, the program codes may be stored in storage means such as a hard disk or a memory of the system or the apparatus or a storage medium such as CD-RW, CD-R or the like, and the computer (or CPU or MPU) of the system or apparatus may read and execute the program codes stored in the storage means or the storage medium at the time of use.

Finally, it is necessary to understand that the processes and techniques described herein are inherently unrelated to any particular apparatus and may be implemented by any suitable combination of components. Furthermore, various types of general-purpose apparatuses may be used according to the teachings described herein. It may be beneficial to build a dedicated device to execute the steps of the methods described herein. In addition, various inventions may be formed by appropriately combining a plurality of constituent elements disclosed in the embodiments. For example, some constituent elements may be deleted from all the constituent elements shown in the embodiments. Furthermore, the constituent elements of different embodiments may be appropriately combined. The present disclosure has been described with reference to specific examples, but these examples are for the purpose of description rather than a limitation in all aspects. Those skilled in the art will appreciate that there are numerous combinations of hardware, software, and firmware suitable for implementing the present disclosure. For example, the described software may be implemented in a wide range of programs or scripting languages such as assembler, C/C++, Perl, Shell, PHP, Java (registered trademark), and the like.

Furthermore, in the above embodiments, the control lines and the information lines indicate what is considered to be necessary for description, and all control lines and information lines are not necessarily shown on a product. All the configurations may be mutually connected.

In addition, for those who have ordinary knowledge in the art, other implementations of the present disclosure will be apparent from consideration of the specification and embodiments of the present disclosure disclosed herein. The various aspects and/or components of the described embodiments may be used alone or in any combination. The specification and specific examples are exemplary only, and the scope and spirit of the present disclosure is indicated by the claims that follow.

### REFERENCE SIGNS LIST

101, 103 semiconductor laser
102, 104 signal generator
105, 107, 111, 801, 802, 804, 806, 807, 809, 901, 904, 1001, 1003, 1102, 1106, 1403, 1500, 1501, 1502, 1504, 1509 fiber coupler
106, 1101, 1105, 1402 circulator
108, 1103, 1107 reference mirror
109 collimator lens (fiber collimator)
110 measurement target
112, 113, 203, 805, 810, 1004, 1109, 1407, 1510 light receiver
114 computer (PC)
115 monitor
116 inner diameter measurement target
201, 1405, 1406 reference mirror
202 beam splitter
301 beat signal
803, 808, 1002, 1505, 1506, 1507 optical fiber
902, 905 feedback mechanism
903, 906 combiner
1005 signal oscillator
1006 mixer
1104, 1108, 1401, 1404, 1503, 1508 WDM coupler
1201, 1202 beat signal detected by light receiver
1601 3D shape measurement unit
1602, 1802 distance measurement unit
1603, 1803 1 axis stage
1604, 1804 focus lens
1605, 1605 Galvano mirror
1805 reflecting prism
1806 rotary stage

1. A distance measuring apparatus that measures a distance from a light source to a measurement target, the apparatus comprising:
a light source unit that emits a plurality of outgoing light beams having different wavelengths;
an irradiation optical element that irradiates the measurement target with the outgoing light beams;
a light receiving unit that receives reflected light which is the outgoing light beams reflected from the measurement target, and
a processor that calculates the distance from the light source to the measurement target using a signal detected by the light receiving unit,
wherein the processor executes frequency calculation processing of calculating a peak frequency corresponding to each of the wavelengths based on the signal and distance calculation processing of reducing the Doppler shift errors caused by the oscillation of the measurement target based on each of the peak frequencies and calculating the distance.

2. The distance measuring apparatus according to claim 1,
wherein the plurality of outgoing lights emitted from the light source unit have different optical axes immediately after emission, the apparatus further comprises:
a multiplexing optical element that multiplexes the plurality of outgoing light beams to obtain coaxial light, and
the coaxial light is irradiated to the measurement target.

3. The distance measuring apparatus according to claim 2,
wherein the multiplexing optical element is constituted by a WDM coupler or a dichroic mirror.

4. The distance measuring apparatus according to claim 2, further comprising:
a branching optical element that branches the coaxial light; and
a reference mirror,
wherein a part of the light branched by the branching optical element is guided to the reference mirror and
light other than the light guided to the reference mirror is guided to the irradiation optical element.

5. The distance measuring apparatus according to claim 4,
wherein the branching optical element is a fiber coupler and
the irradiation optical element is a collimator lens.

6. The distance measuring apparatus according to claim 1,
wherein the light receiving unit receives the light reflected by the measurement target in accordance with the wavelength of the outgoing light.

7. The distance measuring apparatus according to claim 1,
wherein the light source unit sweeps the optical frequencies of the plurality of outgoing light beams to output the swept light beams such that the frequency sweep cycles of the plurality of outgoing light beams having different wavelengths are shifted by a predetermined cycle.

8. The distance measuring apparatus according to claim 1, further comprising:
a calibration interferometer that reduces errors caused by the nonlinearity of the optical frequency sweep in the light source unit.

9. The distance measuring apparatus according to claim 1, further comprising:
a feedback mechanism that generates a signal for controlling an injection current of the light source unit from apart of the outgoing light emitted from the light source unit and feeding the signal back to the light source unit.

10. The distance measuring apparatus according to claim 4,
wherein, when the light source unit emits first light having a wavelength ν1 and second light having a wavelength ν2, which are modulated with a modulation cycle T and transmitted with a frequency sweep width Δν,
the reference mirror generates reference light for each of the first light and the second light,
a time difference between the reference light and the light reflected by the measurement target is set to Δt, a Doppler shift amount of the first light is set to Δf1, a Doppler shift amount of the second light is set to Δf2, and a beat frequency is set to f_{beat},
the processor reduces the Doppler shift errors and calculates a distance L based on the following equation.
$$L = \frac{cT}{2 Δ ν} \cdot \frac{{ν}_{1} {ν}_{2}}{{ν}_{1} + {ν}_{2}} [ \frac{1}{{ν}_{1}} ( {f}_{beat} + Δ {f}_{1} ) + \frac{1}{{ν}_{2}} ( {f}_{beat} - Δ {f}_{2} ) ]$$

11. A shape measuring apparatus comprising:
the distance measuring apparatus according to claim 1;
a focus lens that focuses the light from the distance measuring apparatus on a shape measurement target; and
a mirror for scanning the focused light on the shape measurement target,
wherein the processor calculates a three-dimensional shape of the shape measurement target by using a distance from the light source unit to the shape measurement target measured by the distance measuring apparatus and a scanning angle of the light whose focus is adjusted and outputs the three-dimensional shape measurement result.

12. A distance measuring method of measuring a distance from a light source to a measurement target, the method comprising:
emitting a plurality of outgoing light beams having different wavelengths;
irradiating the measurement target with the outgoing light beams;
receiving the reflected light reflected by the measurement target;
calculating a peak frequency corresponding to each wavelength based on a signal obtained by receiving the reflected light;
reducing the Doppler shift errors caused by the oscillation of the measurement target based on each of the peak frequencies to calculate the distance.
